(19) United States
(12) Patent Application Publication
(10) Pub. No.: US 2020/0211043 A1
(43) Pub. Date: Jul. 2, 2020

(54) INFORMATION PROCESSING DEVICE, INFORMATION PROCESSING METHOD, AND NON-TRANSITORY STORAGE MEDIUM IN WHICH PROGRAM IS STORED

(71) Applicant: TOYOTA JIDOSHA KABUSHIKI KAISHA, Toyota-shi (JP)

(72) Inventors: Takashige Hori, Aisai-shi (JP); Makoto Akahane, Nagoya-shi (JP); Ken Ishikawa, Nagakute-shi (JP); Masatoshi Takahara, Okazaki-shi (JP)

(73) Assignee: TOYOTA JIDOSHA KABUSHIKI KAISHA, Toyota-shi (JP)

(21) Appl. No.: 16/720,907

(22) Filed: Dec. 19, 2019

(30) Foreign Application Priority Data
Dec. 27, 2018 (JP) 2018-245391

(51) Int. Cl. G06Q 30/02; G01C 21/34; G01C 21/36; G08G 1/01

(52) U.S. Cl. CPC G06Q 30/0206; G01C 21/3469; G08G 1/0141; G01C 21/3679; G01C 21/3617

(57) ABSTRACT

An information processing device includes circuitry configured to predict a future fuel consumption amount of a vehicle, based on information relevant to an actual result of a fuel consumption amount of the vehicle and information relevant to a plan of a user of the vehicle; and configured to predict a fuel replenishment timing at which a fuel replenishment of the vehicle is needed, based on the future fuel consumption amount of the vehicle and information relevant to a remaining fuel amount of the vehicle.

### INCORPORATION BY REFERENCE

The disclosure of Japanese Patent Application No. 2018-245391 filed on Dec. 27, 2018 including the specification, drawings and abstract is incorporated herein by reference in its entirety.

### BACKGROUND

### 1. Technical Field

The disclosure relates to an information processing device, an information processing method, and a non-transitory storage medium in which a program is stored.

### 2. Description of Related Art

There is known a technology of predicting a fuel consumption amount in a certain period using information (for example, the average value of past fuel consumption amounts on an identical day of the week) relevant to past fuel consumption amounts of the vehicle (see Japanese Patent Application Publication No. 2014-157021, for example).

### SUMMARY

By the way, it is conceivable to predict a timing at which a fuel replenishment is needed, using the predicted fuel consumption amount.

However, in the above-described technology, the information relevant to past fuel consumption amounts is used. Therefore, for example, in the case where there is a special plan in which a user moves for a relatively longer distance than usual, the actual fuel consumption amount in the plan can differ from the information relevant to past fuel consumption amounts, as exemplified by the average value of past fuel consumption amounts on an identical day of the week. Consequently, for example, in the case where the timing at which the fuel replenishment is needed is predicted mainly in consideration of a plurality of daily uses of the vehicle for relatively short distances, there is a possibility that prediction accuracy for the fuel consumption amount of the vehicle decreases, so that it is not possible to accurately predict the timing at which the fuel replenishment is needed.

The disclosure provides an information processing device and the like that make it possible to accurately predict the timing at which the fuel replenishment of the vehicle is needed.

A first aspect of the disclosure is an information processing device. The information processing device includes circuitry configured to: predict a future fuel consumption amount of a vehicle, based on information relevant to an actual result of a fuel consumption amount of the vehicle and information relevant to a plan of a user of the vehicle; and predict a fuel replenishment timing at which a fuel replenishment of the vehicle is needed, based on the future fuel consumption amount of the vehicle and information relevant to a remaining fuel amount of the vehicle.

With the first aspect, the information processing device can use a past plan and a future plan of the user of the vehicle. Therefore, the information processing device can know the actual result of the fuel consumption amount of the vehicle when the user used the vehicle in the past plan, and can predict the fuel consumption amount by the future use of the vehicle, from the relationship between the past plan and the actual result of the fuel consumption amount, in view of the future plan of the user. Consequently, the information processing device can more accurately predict the timing at which the fuel replenishment of the vehicle is needed, by using the future fuel consumption amount predicted in view of the future plan of the user and the remaining fuel amount of the vehicle.

In the first aspect, the circuitry may be configured to: associate the actual result of the fuel consumption amount of the vehicle, for each past plan that is related to use of the vehicle and that is known from the information relevant to the plan of the user, based on the information relevant to the actual result of the fuel consumption amount of the vehicle; predict the fuel consumption amount of the vehicle for each future plan that is related to the use of the vehicle and that is known from the information relevant to the plan of the user, based on the actual result of the fuel consumption amount of the vehicle associated for each past plan; and predict the timing at which the fuel replenishment of the vehicle is needed, based on the fuel consumption amount of the vehicle for each future plan and the information relevant to the remaining fuel amount of the vehicle.

With the above configuration, using the past plan and future plan of the user of the vehicle, the information processing device can specifically predict the future fuel consumption amount of the vehicle, and can predict the timing at which the fuel replenishment of the vehicle is needed.

In the first aspect, the circuitry may be configured to: estimate a plan that is related to the use of the vehicle and that is unregistered as the information relevant to the plan of the user; associate the actual result of the fuel consumption amount of the vehicle for each past plan that is related to the use of the vehicle and that is registered as the information relevant to the plan of the user, and for each past plan that is related to the use of the vehicle and that is unregistered as the information relevant to the plan of the user, based on the information relevant to the actual result of the fuel consumption amount of the vehicle; and predict the fuel consumption amount of the vehicle for each future plan that is related to the use of the vehicle and that is registered as the information relevant to the plan of the user, and for each future plan that is related to the use of the vehicle and that is unregistered as the information relevant to the plan of the user, based on the actual result of the fuel consumption amount of the vehicle associated for each past plan.

With the above configuration, the information processing device can estimate an unregistered plan that the user does not bother to register, as exemplified by work trip, and can use not only registered past and future plans but also unregistered past and future plans. Therefore, the information processing device can more minutely know the relationship between the actual result of the fuel consumption amount of the vehicle and the plan related to the use of the vehicle by the user. Consequently, the information processing device can further accurately the timing at which the fuel replenishment of the vehicle is needed.

In the first aspect, a part of the information relevant to the plan of the user may be information relevant to a route between a departure place and a destination place corresponding to a plan that is related to the use of the vehicle and that is registered. The circuitry may be configured to predict the fuel consumption amount of the vehicle for a future plan that is related to the use of the vehicle and that is registered as the information relevant to the plan of the user, based on the actual result of the fuel consumption amount of the vehicle associated with a past plan that is related to the use of the vehicle and that is registered as the information relevant to the plan of the user, based on information relevant to the route corresponding to the past plan, and based on information relevant to the route corresponding to the future plan that is related to the use of the vehicle and that is registered as the information relevant to the plan of the user.

With the above configuration, the information processing device can know the route between the departure place and destination place corresponding to each of the past plan and the future plan that are related to the use of the vehicle and that are registered by the user, and can use the information (for example, distance, gradient and limiting speed) relevant to the route. Therefore, for example, the information processing device can know similarities and differences in the information relevant to the route corresponding to each of the past plan and the future plan, and can specifically predict the fuel consumption amount of the vehicle corresponding to the future plan, from the actual result of the fuel consumption amount of the vehicle corresponding to the past plan.

In the first aspect, the circuitry may be configured to predict the fuel consumption amount of the vehicle for the future plan that is related to the use of the vehicle and that is registered as the information relevant to the plan of the user, based on actual result information relevant to a congestion situation on the route on a date and hour in the past plan that is related to the use of the vehicle and that is registered as the information relevant to the plan of the user, and based on prediction information relevant to a congestion situation on the route on a date and hour in the future plan that is related to the use of the vehicle and that is registered as the information relevant to the plan of the user.

With the above configuration, the information processing device can use the actual result information relevant to the congestion situation on the route corresponding to the past plan on the date and hour in the past plan, and the prediction information relevant to the congestion situation on the route corresponding to the future plan on the date and hour in the future plan. Therefore, the information processing device can predict the fuel consumption amount of the vehicle corresponding to the future plan, from the actual result of the fuel consumption amount of the vehicle corresponding to the past plan, in consideration of the congestion situations on the route at the times of uses of the vehicle corresponding to the past plan and the future plan. Consequently, the information processing device can more accurately predict the fuel consumption amount of the vehicle corresponding to the future plan.

In the first aspect, the circuitry may be configured to provide, to the user, information relevant to the timing at which the fuel replenishment of the vehicle is needed, through a user terminal.

With the above configuration, the information processing device can prompt the user to perform the fuel replenishment at a more appropriate timing.

In the first aspect, the circuitry may be configured to provide, to the user, information relevant to a fuel replenishment facility as waypoint on a movement route corresponding to a particular plan before the timing at which the fuel replenishment of the vehicle is needed. The particular plan may be a future plan that is related to the use of the vehicle and that is registered as the information relevant to the plan of the user.

With the above configuration, the information processing device can specifically provide the information relevant to a fuel replenishment facility that is around the movement route corresponding to the future plan and at which the user can stop off, as the information relevant to the timing at which the fuel replenishment of the vehicle is needed.

In the first aspect, the circuitry may be configured to provide, to the user, the information relevant to the fuel replenishment facility as the waypoint on the movement place corresponding to a plan for a day on which it is predicted that a fuel price is relatively low before the timing at which the fuel replenishment of the vehicle is needed, based on prediction information relevant to the fuel price, the plan being a future plan that is related to the use of the vehicle and that is registered as the information relevant to the plan of the user.

With the above configuration, the information processing device can perform the information provision to the user, such that the user can stop off at the fuel replenishment facility at a timing at which the fuel price is relatively low before the predicted timing at which the fuel replenishment of the vehicle is needed.

In the first aspect, the circuitry may be configured to provide, to the user, the information relevant to the fuel replenishment facility as the waypoint, based on information relevant to a movement history of the vehicle.

With the above configuration, by using the movement history of the vehicle, the information processing device can know the preference (for example, a fuel replenishment facility that is frequently used, and information of whether the fuel replenishment facility at which the user stops off is a self-service type or a full-service type) of the user relevant to the fuel replenishment facility. Consequently, the information processing device can provide, to the user, the information relevant to the fuel replenishment facility as the stop place, in view of the preference of the user relevant to the fuel replenishment facility.

In the first aspect, the circuitry may be configured to select the fuel replenishment facility as the waypoint from fuel replenishment facilities, based on information relevant to a congestion degree for each of the fuel replenishment facilities, and provide, to the user, information relevant to the fuel replenishment facility that is selected.

With the above configuration, by using the information relevant to the congestion degree for each of the plurality of fuel replenishment facilities, for example, the information processing device can provide, to the user, information relevant to a fuel replenishment facility that is not relatively congested, as the stop place of the plurality of fuel replenishment facilities.

A second aspect of the disclosure is an information processing method that is executed by an information processing device. The information processing method includes: a fuel consumption amount predicting step of predicting a future fuel consumption amount of a vehicle, based on information relevant to an actual result of a fuel consumption amount of the vehicle and information relevant to a plan of a user of the vehicle; and a fuel replenishment timing predicting step of predicting a timing at which a fuel replenishment of the vehicle is needed, based on the future fuel consumption amount of the vehicle predicted in the fuel consumption amount predicting step and information relevant to a remaining fuel amount of the vehicle.

A third aspect of the disclosure is a non-transitory storage medium in which a program is stored. The program is executed by an information processing device and causing the information processing device to execute: a fuel consumption amount predicting step of predicting a future fuel consumption amount of a vehicle, based on information relevant to an actual result of a fuel consumption amount of the vehicle and information relevant to a plan of a user of the vehicle; and a fuel replenishment timing predicting step of predicting a timing at which a fuel replenishment of the vehicle is needed, based on the future fuel consumption amount of the vehicle predicted in the fuel consumption amount predicting step and information relevant to a remaining fuel amount of the vehicle.

The first aspect, the second aspect and the third aspect, it is possible to predict accurately the timing at which the fuel replenishment of the vehicle is needed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing an example of a configuration of an information providing system;

FIG. 2A is a diagram showing an example of a hardware configuration of a vehicle;

FIG. 2B is a diagram showing an example of a hardware configuration of a vehicle information server, a plan information server and a user terminal;

FIG. 3 is a functional block diagram showing an example of a functional configuration of the information providing system;

FIG. 4A is a diagram showing an example of a plan information display screen;

FIG. 4B is a diagram showing an alternative example of the plan information display screen; and

FIG. 4C is a diagram showing a further alternative example of the plan information display screen.

### DETAILED DESCRIPTION OF EMBODIMENTS

Hereinafter, an embodiment of the disclosure will be described with reference to the drawings.

Outline of Information Providing System

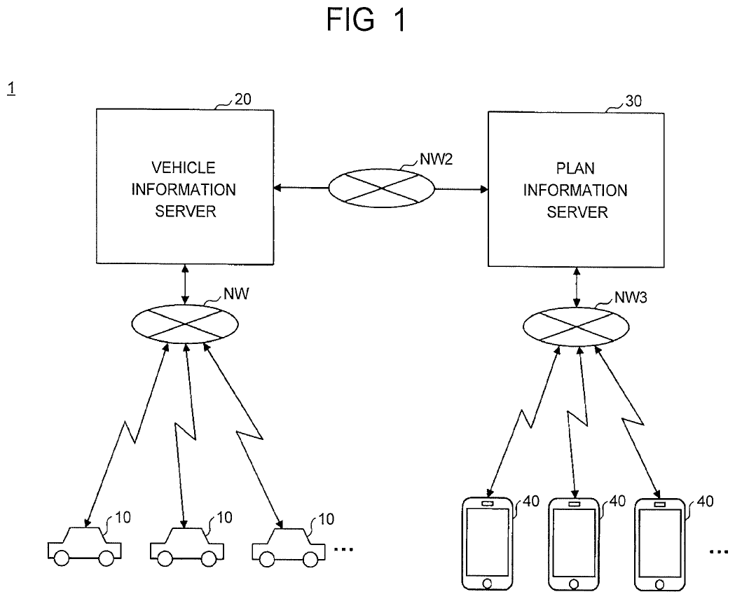

First, an outline of an information providing system 1 according to the embodiment will be described with reference to FIG. 1.

The information providing system 1 includes a plurality of vehicles 10, a vehicle information server 20, a plan information server 30, and a plurality of user terminals 40.

The information providing system 1 provides plan information that is registered by a user, and information (hereinafter, referred to as “fuel replenishment timing information”) relevant to a timing (hereinafter, referred to as a “fuel replenishment timing”) at which fuel replenishment of the vehicle 10 by the user is needed, from the plan information server 30 to the user through the user terminal 40. Hereinafter, for distinction, in some cases, a user of the information providing system 1, in other words, a user that uses the plan information server 30 through a later-described scheduler app is referred to as an “app user”, and a user that uses the vehicle 10 is referred to as a “vehicle user”. In the embodiment, a case where the app user is the vehicle user without exception will be mainly described.

The vehicle 10 travels while generating driving power using fuel that is replenished from the exterior. For example, the vehicle 10 is an engine-equipped vehicle that drives an engine using gasoline, light oil or the like. On this occasion, the engine-equipped vehicle performs at least one of transmitting driving power of the engine to driving wheels and transmitting driving power of an electric motor to the driving wheels. The electric motor is driven by electric power of an electric generator, and the electric generator is driven by the driving power of the engine. Further, for example, the vehicle 10 may be a fuel cell vehicle that drives an electric motor for vehicle driving, with electric power of a fuel cell using hydrogen and the like as fuel. Hereinafter, in the embodiment, a case where the vehicle 10 is the engine-equipped vehicle will be mainly described.

For example, the vehicle 10 is communicably connected with the vehicle information server 20, through a communication network NW1 that can include a mobile communication network using base stations as terminals, a satellite communication network using overhead communication satellites, and an internet network. The vehicle 10 acquires a prescribed kind of dynamic information (hereinafter, referred to as “vehicle information”) related to the vehicle 10 (own vehicle), and uploads (sends) the acquired vehicle information to the vehicle information server 20, in response to a command from the vehicle information server 20 or automatically at a prescribed timing. For example, the vehicle information includes information (hereinafter, referred to as “vehicle state information”) relevant to various states of the vehicle 10 such as a position state of the vehicle 10, a motion state of the vehicle 10, an operation state of the vehicle 10 by a driver or the like, and a control state of the vehicle 10. Here, the vehicle state information includes information (hereinafter, referred to as “fuel consumption related information”) related to fuel consumption of the vehicle 10. Further, for example, the vehicle information includes information (hereinafter, referred to as “environment state information”) relevant to an environment state of the periphery of the vehicle 10, as exemplified by the ambient temperature of the periphery of the vehicle 10 that is obtained by a temperature sensor, and a rainfall state (specifically, existence of a raindrop and the amount of the raindrop) of the periphery of the vehicle 10 that is obtained by a rain sensor.

The vehicle information server 20 is communicably connected with each of the plurality of vehicles 10, through the communication network NW1. The vehicle information server 20 receives the vehicle information that is sent from each of the plurality of vehicles 10, and accumulates the received vehicle information for each vehicle 10.

For example, the vehicle information server 20 is communicably connected with the plan information server 30, through a communication network NW2 that can include an internet network and the like. The vehicle information server 20 sends the latest vehicle information including the fuel consumption related information about the vehicle 10, in response to a request from the plan information server 30 or automatically at a prescribed timing. The latest vehicle information means vehicle information that is newly acquired after the last sending of the vehicle information to the plan information server 30, and specifically, may be a record group (including vehicle identification information and acquisition date-and-hour information) of pieces of vehicle information different in date and hour of acquisition. For example, the fuel consumption related information can include information (hereinafter, referred to as “remaining fuel amount information”) relevant to the remaining fuel amount of the vehicle 10 at each time point, information (hereinafter, referred to as “fuel consumption amount actual result information”) relevant to the actual result of the fuel consumption amount of the vehicle 10 after the most recent past time point at each time point, and information relevant to whether the fuel was replenished to the vehicle 10 between the most recent time points. On this occasion, the fuel consumption amount of the vehicle 10 after the most recent past time point at each time point can be derived as the difference between the remaining fuel amounts at the respective time points. Further, for example, whether the fuel was replenished can be determined based on whether the remaining fuel amount was increased between the adjacent time points.

The plan information server 30 manages plan information (referred to as “schedule information”) for each of a plurality of app users including vehicle users. Specifically, for example, the plan information server 30 is communicably connected with user terminals 40 that are used by a plurality of users respectively, through a communication network NW3 that can include a mobile communication network using base stations as terminals, a satellite communication network using overhead communication satellites, and an internet network. The plan information server 30 registers information (hereinafter, referred to as “plan information”) relevant to a plan of the app user, or displays the plan information about the app user to the user terminal 40, in response to an app user's operation of a predetermined app program (hereinafter, referred to as a “scheduler app”) installed in the user terminal 40.

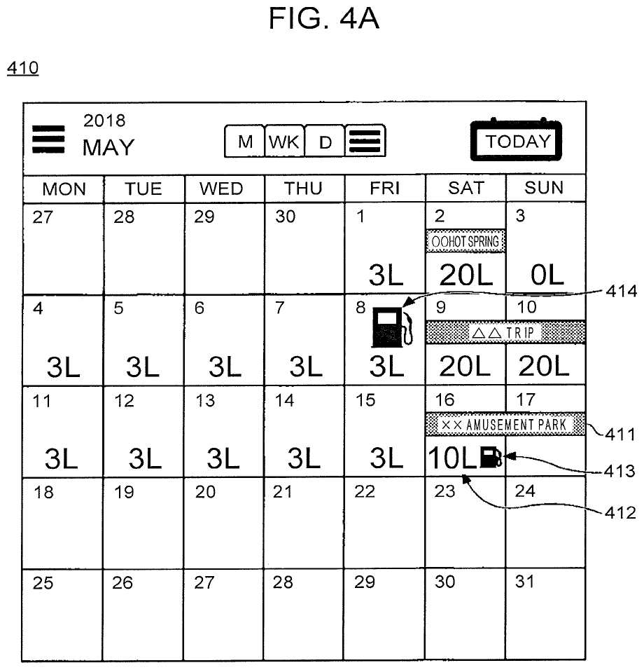

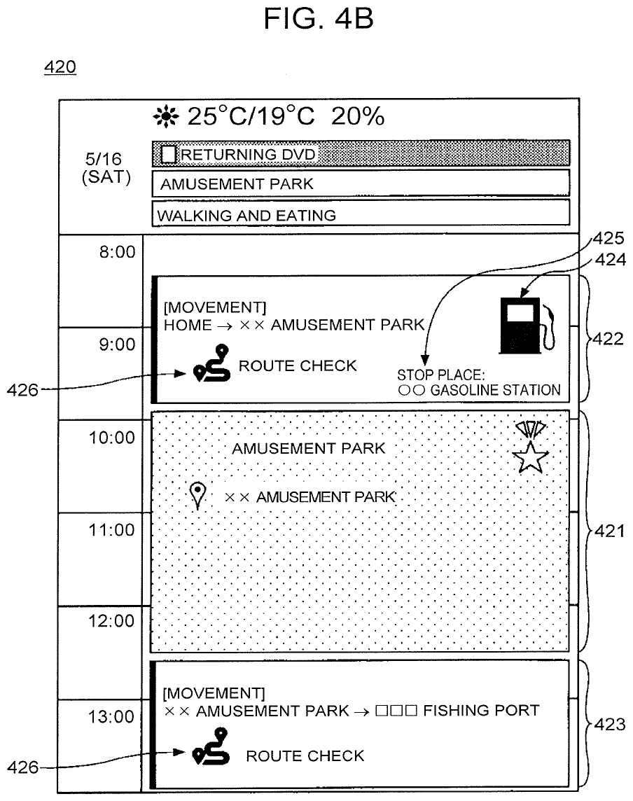

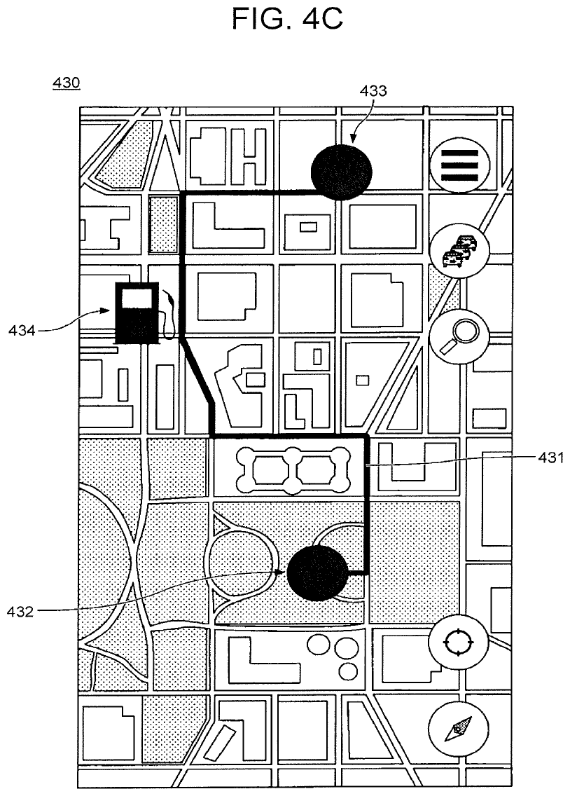

The plan information server 30 is communicably connected with the vehicle information server 20, through the communication network NW2. Periodically (for example, at a decided hour every day), the plan information server 30 acquires the latest vehicle information including the fuel consumption related information about the vehicle 10 that is used by the app user, from the vehicle information server 20. The plan information server 30 predicts a future fuel consumption amount of the vehicle 10, based on the fuel consumption related information about the vehicle 10 that is used by the app user (concurrently the vehicle user) and the plan information about the app user that uses the vehicle 10, and predicts a fuel replenishment timing of the vehicle 10, based on the predicted future fuel consumption amount. Then, based on the prediction result, the plan information server 30 provides the fuel replenishment timing information, through the user terminal 40, to the app user that uses the vehicle 10, that is, to the vehicle user of the vehicle 10. Details will be described later (see FIG. 4A to FIG. 4C, for example).

For example, the user terminal 40 is a mobile terminal such as a smartphone, a mobile phone, a tablet terminal and a laptop computer. Further, for example, the user terminal 40 may be a stationary terminal such as a desktop computer. Further, for example, the user terminal 40 may be a terminal that is equipped in the vehicle 10, that is, an in-vehicle device (for example, a head unit of a navigation device or the like).

The user terminal 40 is communicably connected with the plan information server 30, through the communication network NW3. In response to an app user's operation of the scheduler app, the user terminal 40 requests the registration of the plan information in the plan information server 30 or the display of the registered plan information, and thereby, assists the app user to register the plan information or to watch the registered plan information and the replenishment timing information.

Configuration of Information Providing System

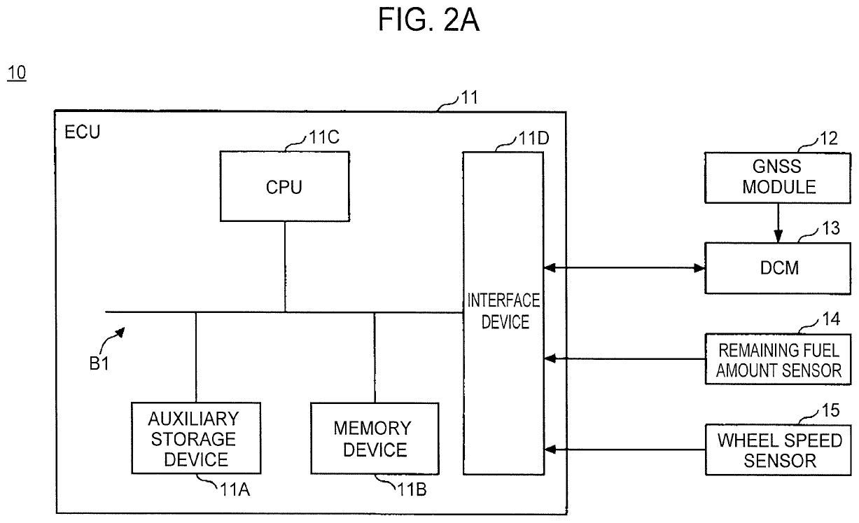

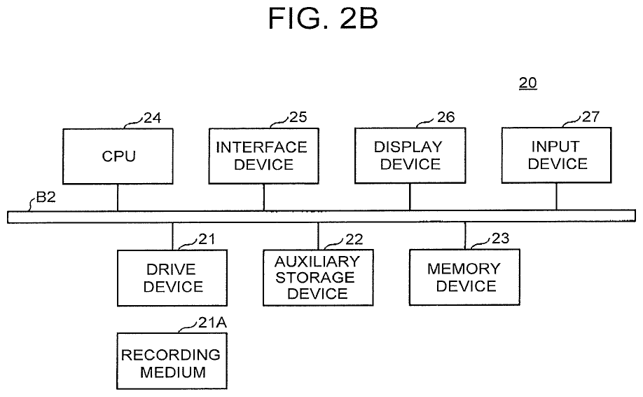

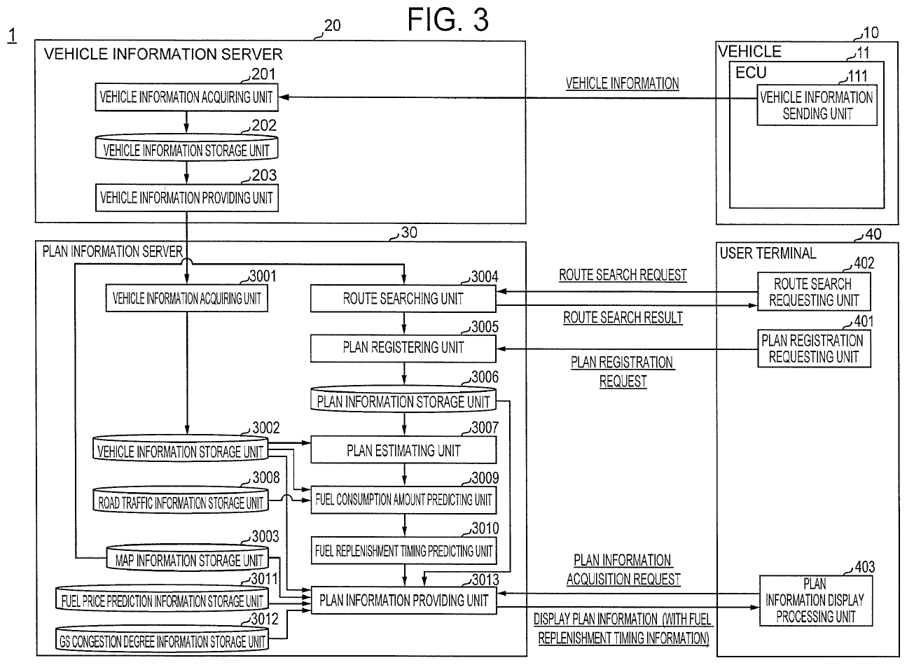

Next, a configuration of the information providing system 1 will be described with reference to FIG. 2A, FIG. 2B and FIG. 3, in addition to FIG. 1.

Each of FIG. 2A and FIG. 2B is a diagram showing an example of a hardware configuration of the information providing system 1. Specifically, FIG. 2A is a diagram showing an example of a hardware configuration of the vehicle 10, and FIG. 2B is a diagram showing an example of a hardware configuration of the vehicle information server 20. FIG. 3 is a functional block diagram showing an example of a functional configuration of the information providing system 1.

Hardware configurations of the plan information server 30 and the user terminal 40 are nearly the same as the hardware configuration of the vehicle information server 20. Therefore, descriptions will be made below, with reference to FIG. 2B, and illustrations of the hardware configurations of the plan information server 30 and the user terminal 40 will be omitted. Hereinafter, in the description of the plan information server 30, reference characters “21”, “21A”, “22”, “23”, “24”, “25”, “26”, “27” and “B2” in FIG. 2B are replaced with “31”, “31A”, “32”, “33”, “34”, “35”, “36”, “37” and “B3”, respectively. Further, in the description of the user terminal 40, reference characters “21”, “21A”, “22”, “23”, “24”, “25”, “26”, “27” and “B2” in FIG. 2B are replaced with “41”, “41A”, “42”, “43”, “44”, “45”, “46”, “47” and “B4”, respectively.

Configuration of Vehicle

As shown in FIG. 2A, the vehicle 10 includes an ECU 11, a global navigation satellite system (GNSS) module 12, a data communication module (DCM) 13, a remaining fuel amount sensor 14 and a wheel speed sensor 15.

The ECU 11 is an electronic control unit that performs various controls relevant to the vehicle 10, and functions of the ECU 11 may be realized by arbitrary hardware or combinations of hardware and software. For example, the ECU 11 may be constituted mainly by a microcomputer including an auxiliary storage device 11A, a memory device 11B, a central processing units (CPU) 11C, an interface device 11D and the like, which are connected with each other by a bus B1.

For example, programs to realize various programs of the ECU 11 are provided by a dedicated tool that is connected with a predetermined connector (for example, a data link coupler (DLC)) for external connection by a detachable cable. The connector is joined to an in-vehicle network such as a controller area network (CAN) of the vehicle 10. In response to a predetermined operation of the dedicated tool, the programs are installed in the auxiliary storage device 11A of the ECU 11 from the dedicated tool through the cable, the connector and the in-vehicle network. Further, the programs may be installed in the auxiliary storage device 11A by being downloaded from another computer (for example, the vehicle information server 20) through the communication network NW1.

The auxiliary storage device 11A, which is non-volatile storage means, contains the installed programs, and contains necessary files, necessary data and the like. For example, the auxiliary storage device 11A is a hard disk drive (HDD), a flash memory or the like.

When an activation instruction for a program is given, the memory device 11B reads the program from the auxiliary storage device 11A, and contains the program.

The CPU 11C executes the programs contained in the memory device 11B, and realizes various functions of the ECU 11 in accordance with the programs.

For example, the interface device 11D is used as an interface for connection with the in-vehicle network and one-to-one connection with various sensors, various actuators and the like. The interface device 11D can include different kinds of interface devices, depending on objects to be connected.

The GNSS module 12 receives satellite signals sent from three or more satellites, preferably, four or more satellites over the vehicle 10, and thereby, measures the position of the vehicle 10 (own vehicle) equipped with the GNSS module 12. Positioning information of the GNSS module 12, that is, position information about the vehicle 10 is taken in the DCM 13, through a one-to-one communication line or the in-vehicle network, for example. The positioning information of the GNSS module 12 may be taken in the ECU 11 from the DCM 13 through the in-vehicle network or the like, for example.

The DCM 13, which is connected with the communication network NW1 in the exterior of the vehicle 10, is an exemplary communication device for communicating with an external device including the vehicle information server 20 through the communication network NW1. The DCM 13 sends and receives various signals (for example, information signals, control signals and the like) for the vehicle information server 20. The DCM 13 is communicably connected with the ECU 11 through the one-to-one communication line or the in-vehicle network such as the CAN. In response to requests from the ECU 11, the DCM 13 sends various signals to the exterior of the vehicle 10 (own vehicle), or outputs signals received from the exterior of the vehicle 10, to the ECU 11.

The remaining fuel amount sensor 14 is known detection means for detecting the remaining fuel amount of the vehicle 10. For example, in the case where the vehicle 10 is an engine-equipped vehicle, the remaining fuel amount sensor 14 detects the remaining fuel amount from a resistance value indicating the level of a float in a fuel tank. A detection signal corresponding to the remaining fuel amount that is detected by the remaining fuel amount sensor 14 is taken in the ECU 11 through the one-to-one communication line, the in-vehicle network or the like.

The wheel speed sensor 15 is known detection means for detecting the wheel speed of each wheel of the vehicle 10. A detection signal that corresponds to the wheel speed of each wheel and that is detected by the wheel speed sensor 15 is taken in the ECU 11 through the one-to-one communication line, the in-vehicle network or the like.

As shown in FIG. 3, for example, the ECU 11 includes a vehicle information sending unit 111, as a functional unit that is realized when the CPU 11C executes one or more programs installed in the auxiliary storage device 11A.

For example, in a predetermined cycle (for example, in a cycle of several minutes to several tens of minutes), the vehicle information sending unit 111 acquires a prescribed kind of vehicle information or causes the DCM 13 to acquires the vehicle information, and sends the vehicle information to the vehicle information server 20 through the DCM 13. The vehicle information to be sent to the vehicle information server 20 includes the position information about the vehicle 10 that is obtained by the GNSS module 12. Further, the vehicle information to be sent to the vehicle information server 20 includes the detection information about the remaining fuel amount that is obtained by the remaining fuel amount sensor 14, or a variety of fuel consumption related information (for example, the fuel consumption amount or fuel replenishment amount in a predetermined time that is calculated from the remaining fuel amount) that is calculated from the detection information. Further, the vehicle information to be sent to the vehicle information server 20 includes the detection information about each wheel that is obtained by the wheel speed sensor 15, or information (hereinafter, referred to as “vehicle speed information”) that is relevant to vehicle speed and that is calculated from the detection information. Specifically, to the vehicle information server 20, the vehicle information sending unit 111 may send a signal including identification information (for example, the vehicle index number (VIN) of the vehicle 10) for specifying the vehicle 10 that is a sending source, a vehicle identifier (ID; hereinafter, referred to as “vehicle identification information”) that is prescribed for each of the plurality of vehicles 10, information (for example, time stamp; hereinafter, referred to as “acquisition date-and-hour information”) relevant to the date and hour of the acquisition of the vehicle information, and the vehicle information. Thereby, the vehicle information server 20 can identify (specify) the vehicle 10 that is the sending source of the signal including the vehicle information, or can specify the date and hour (acquisition timing) of the acquisition of the vehicle information.

The function of the vehicle information sending unit 111 may be transferred to the DCM 13.

Configuration of Vehicle Information Server

Functions of the vehicle information server 20 may be realized by arbitrary hardware or combinations of hardware and software. As shown in FIG. 2B, for example, the vehicle information server 20 includes a drive device 21, an auxiliary storage device 22, a memory device 23, a CPU 24, an interface device 25, a display device 26 and an input device 27, which are connected with each other by a bus B2.

For example, programs to realize various functions of the vehicle information server 20 are provided by a portable recording medium 21A such as a compact disc read only memory (CD-ROM), a digital versatile disc read only memory (DVD-ROM) or a universal serial bus (USB) memory. When the recording medium 21A in which the programs are recorded are set in the drive device 21, the programs are installed in the auxiliary storage device 22 from the recording medium 21A through the drive device 21. Further, the programs may be downloaded from another computer through the communication network, and may be installed in the auxiliary storage device 22.

The auxiliary storage device 22 contains the installed various programs, and contains necessary files, necessary data and the like.

When an activation instruction for a program is given, the memory device 23 reads the program from the auxiliary storage device 22, and contains the program.

The CPU 24 executes the various programs stored in the memory device 23, and realizes various functions about the vehicle information server 20 in accordance with the programs.

The interface device 25 is used as an interface for connection with communication networks (for example, the communication networks NW1, NW2).

For example, the display device 26 displays a graphical user interface (GUI) in accordance with programs that are executed by the CPU 24.

The input device 27 is used when an operator, an administrator or the like of the vehicle information server 20 inputs various operation instructions relevant to the vehicle information server 20.

As shown in FIG. 3, for example, the vehicle information server 20 includes a vehicle information acquiring unit 201 and a vehicle information providing unit 203, as functional units that are realized when the CPU 24 executes one or more programs installed in the auxiliary storage device 22. Further, the vehicle information server 20 uses a vehicle information storage unit 202 and the like. For example, the vehicle information storage unit 202 can be realized using the auxiliary storage device 22 or an external storage device or the like that is communicably connected with the vehicle information server 20.

The vehicle information acquiring unit 201 acquires the vehicle information included in the signal received from each of the plurality of vehicles 10, and stores (accumulates) the vehicle information in the vehicle information storage unit 202. Specifically, the vehicle information acquiring unit 201 stores the vehicle information received from the vehicle 10, in the vehicle information storage unit 202, as a record associated with the corresponding vehicle identification information and acquisition date-and-hour information.

In the vehicle information storage unit 202, as described above, the vehicle information received from the vehicle 10 is stored. Specifically, the vehicle information storage unit 202 may hold a record group (that is, a database) of the vehicle information acquired by the plurality of vehicles 10, by accumulating records including the vehicle identification information, the acquisition data-and-hour information and the vehicle information. Further, the vehicle information storage unit 202 may be provided with a vehicle information storage unit dedicated for each of the plurality of vehicles 10, and may hold a history of records of the acquisition date-and-hour information and the vehicle information for each vehicle 10, that is, a record group, in the corresponding vehicle information storage unit.

The vehicle information providing unit 203 provides (sends) the latest vehicle information including the fuel consumption related information, the vehicle speed information and the position information about each of the plurality of vehicles 10, to the plan information server 30, in response to a request from the plan information server 30, or periodically at prescribed timings.

Configuration of Plan Information Server

Similarly to the vehicle information server 20, functions of the plan information server 30 may be realized by arbitrary hardware or combinations of hardware and software. As shown in FIG. 2B, for example, the plan information server 30 includes a drive device 31, an auxiliary storage device 32, a memory device 33, a CPU 34, an interface device 35, a display device 36 and an input device 37, which are connected with each other by a bus B3.

A hardware configuration of the plan information server 30 is nearly the same as the hardware configuration of the vehicle information server 20, and therefore, detailed descriptions will be omitted.

As shown in FIG. 3, for example, the plan information server 30 includes a vehicle information acquiring unit 3001, a route searching unit 3004, a plan registering unit 3005, a plan estimating unit 3007, a fuel consumption amount predicting unit 3009, a fuel replenishment timing predicting unit 3010, and a plan information providing unit 3013, as functional units that are realized when the CPU 34 executes one or more programs installed in the auxiliary storage device 32. Further, the plan information server 30 uses a vehicle information storage unit 3002, a map information storage unit 3003, a plan information storage unit 3006, a road traffic information storage unit 3008, a fuel price prediction information storage unit 3011, a fuel replenishment facility congestion degree information storage unit (hereinafter, referred to as a “GS congestion degree information storage unit”) 3012, and the like. The vehicle information storage unit 3002, the map information storage unit 3003, the plan information storage unit 3006, the road traffic information storage unit 3008, the fuel price prediction information storage unit 3011, the GS congestion degree information storage unit 3012, and the like can be realized, for example, using the auxiliary storage device 32 or an external storage device or the like that is communicably connected with the plan information server 30.

The vehicle information acquiring unit 3001 acquires the latest vehicle information received from the vehicle information server 20, and stores (accumulates) the vehicle information in the vehicle information storage unit 3002. Specifically, the vehicle information acquiring unit 3001 stores, in the vehicle information storage unit 3002, a record group of the vehicle information that corresponds to the latest vehicle information for each of the plurality of vehicles 10 and that is received from the vehicle information server 20. On this occasion, the vehicle information acquiring unit 3001 associates the latest vehicle information about a certain vehicle 10, with identification information (for example, a user ID specific to an app user; hereinafter, referred to as “user identification information”) about an app user corresponding to the certain vehicle 10, that is, an app user of the vehicle user of the certain vehicle 10. More specifically, by adding a field for the user identification information to a record group of the vehicle information about a certain vehicle 10, the vehicle information acquiring unit 3001 may generate a record group of the vehicle information including the user identification information about an app user corresponding to the certain vehicle 10, and may store the record group in the vehicle information storage unit 3002. Further, there is a possibility that a plurality of app users shares one vehicle 10. In this case, the vehicle information acquiring unit 3001 may associate the latest vehicle information about the vehicle 10, with the plurality of app users.

In the vehicle information storage unit 3002, as described above, the latest vehicle information provided from the vehicle information server 20 is stored (accumulated). Specifically, whenever the latest vehicle information is provided from the vehicle information server 20, the vehicle information storage unit 3002 may accumulate the corresponding latest record group, and thereby, may hold a history (that is, a database) of past records of the vehicle information including the vehicle identification information, the user identification information, the acquisition date-and-hour information and the vehicle information. Further, the vehicle information storage unit 3002 may be provided with a vehicle information storage unit dedicated for each of the plurality of vehicles 10, and may hold a history of records including the user identification information, the acquisition date-and-hour information and the vehicle information for each vehicle 10, in the corresponding vehicle information storage unit.

In the map information storage unit 3003, map information for a prescribed geographical range (hereinafter, referred to as an “object range”) including a route search object range by the route searching unit 3004 described later and a search object range for the fuel replenishment facility by the plan information providing unit 3013 is stored. For example, the map information includes road information including position information about links and nodes of roads, the type of each road, and the like. Further, the map information includes information (hereinafter, referred to as “POI information”) relevant to a point of interest (POI) in the object range.

The route searching unit 3004 searches a route from a departure place to a destination place based on the map information in the map information storage unit 3003, in response to a route search request received from the user terminal 40 or a request from the plan registering unit 3005. Then, the route searching unit 3004 outputs one or a plurality of routes from the departure place to the destination place, required times and the like, as a route search result.

In response to a plan registration request received from the user terminal 40, the plan registering unit 3005 registers a date and hour and plan content designated in the plan registration request, in the plan information storage unit 3006, as the plan information about the app user corresponding to the user identification information designated in the plan registration request. The plan content designated in the plan registration request can include information (hereinafter, referred to as “route designation information”) designating a movement route in the plan and at least one of an outward route to a place corresponding to the plan and a homeward route from the place corresponding to the plan. In this case, the plan registering unit 3005 acquires information (for example, a designated route from the departure place to the destination place, the required time and the like; hereinafter, referred to as “route information”) relevant to the route designated in the route designation information, from the route searching unit 3004, and incorporates the route information in the plan information to be registered. Further, as an incidental plan for conducting the plan to be registered, the plan registering unit 3005 may add a plan (hereinafter, referred to as an “incidental movement plan”) corresponding to a movement by the vehicle 10 to the place corresponding to the plan or from the place corresponding to the plan, and may incorporate the incidental movement plan in the plan information to be registered.

In the case where the plan registration request received from the user terminal 40 does not include the route designation information, the plan registering unit 3005 may request the route search for the movement route in the plan designated in the plan registration request, to the route searching unit 3004, regardless of the request from the user. Further, in the case where the plan registration request received from the user terminal 40 does not include the route designation information, the plan registering unit 3005 may request the route search for the outward route to the place corresponding to the plan designated in the plan registration request or the homeward route from the place corresponding to the plan, to the route searching unit 3004, regardless of the request from the user. In this case, the plan registering unit 3005 may estimate the departure place, in consideration of a period of time in the plan, places corresponding to plans immediately before and after the plan, and the like.

In the plan information storage unit 3006, the plan information for each of the plurality of app users is registered (stored). Specifically, in the plan information storage unit 3006, a plan table database for each of the plurality of app users is held, and the plan information for each app user is registered in the plan table database for the app user.

Periodically (for example, at weekly intervals), the plan estimating unit 3007 estimates a plan of the app user that is not registered as the plan information for each of the plurality of app users, specifically, a plan of the app user that is related to the use of the vehicle 10. The plan that is related to the use of the vehicle 10 includes not only a plan that is conducted with the use of the vehicle 10 but also a plan in which the vehicle 10 is used as a precondition for conducting the plan. Here, examples of the plan that is conducted with the use of the vehicle 10 include a plan for a trip in which the user goes to sightseeing spots while moving by the vehicle 10. Examples of the plan in which the vehicle 10 is used as a precondition for conducting the plan include a plan for a visit to a leisure facility such as an amusement park. For example, the plan estimating unit 3007 estimates the plan that is not registered as the plan information, by knowing an action cycle of the user based on the registration status of the plan information about the user and past fuel consumption amounts of the vehicle 10. Specifically, in the case where registered plans of a certain app user that are related to the use of the vehicle 10 are concentrated on particular days (for example, Saturday and Sunday) of the week and where a similar fuel consumption amount is observed every day other than the particular days of the week even though the plan related to the use of the vehicle 10 is not registered, the plan estimating unit 3007 can estimate that the vehicle 10 is used for a work trip, a commuting or the like. That is, the plan estimating unit 3007 can estimate that the unregistered plan related to the vehicle 10 is a “work trip” or “commuting” on the days other than the particular days of the week. The plan estimating unit 3007 stores a date and hour and a content of the estimated plan, in the plan information storage unit 3006, as unregistered plan information. Hereinafter, the plan information registered by the app user is referred to as “registered plan information”, in distinction from the unregistered plan information, and the registered plan information and the unregistered plan information are collectively referred to as the “plan information”.

In the road traffic information storage unit 3008, information (hereinafter, referred to as “road traffic information”) relevant to traffic situations of various roads prescribed by the road information stored in the map information storage unit 3003 is stored. For example, the road traffic information may be periodically acquired from a predetermined external institution (for example, a road traffic information center) in the exterior of the plan information server 30. The road traffic information includes actual result information (hereinafter, referred to as “road congestion situation actual result information”) about a past road congestion situation (for example, information of whether a traffic jam occurs, and the degree of a traffic jam) and prediction information (hereinafter, referred to as “road congestion situation prediction information”) about a future road congestion situation.

For each of the plurality of vehicles 10, the fuel consumption amount predicting unit 3009 periodically predicts a future fuel consumption amount of the vehicle 10, based on the past fuel consumption amount actual result information about the vehicle 10 that is held in the vehicle information storage unit 3002 and the plan information about the app user that uses the vehicle 10.

For example, the fuel consumption amount predicting unit 3009 predicts the fuel consumption amount for each of future plans from tomorrow, in a decided period of time every day (for example, at midnight during which the use frequency of the vehicle 10 is very low), based on the fuel consumption amount actual result information about the vehicle 10 until the previous day, and the plan information until the previous day and the plan information from tomorrow about the app user that uses the vehicle 10.

Specifically, first, based on the past fuel consumption amount actual result information about the vehicle 10, the fuel consumption amount predicting unit 3009 associates the actual result of the fuel consumption amount of the vehicle 10, with a past plan that is related to the use of the vehicle 10 and that is known from the plan information. That is, based on the past fuel consumption amount actual result information about the vehicle 10, the fuel consumption amount predicting unit 3009 associates the actual result of the fuel consumption amount of the vehicle 10, for each of the past plans corresponding to the registered plan information and the past plans corresponding to the unregistered plan information. On this occasion, whether a certain past plan corresponding to the registered plan information is a plan that is related to the use of the vehicle 10 may be determined, for example, by checking whether the registered plan information includes the route information or by observing the change in the fuel consumption amount of the vehicle 10 in the corresponding period of time. More specifically, based on the past fuel consumption amount actual result information about the vehicle 10, the fuel consumption amount predicting unit 3009 acquires (derives) an actual result value of the fuel consumption amount consumed by the use of the vehicle 10 for each of the past plans that are related to the use of the vehicle 10 and that are known from the plan information. Then, the fuel consumption amount predicting unit 3009 associates the acquired actual result value of the fuel consumption amount consumed by the use of the vehicle 10 for each of the past plans, with each corresponding past plan.

As described above, the fuel consumption amount predicting unit 3009 periodically associates the fuel consumption amount of the vehicle 10 with the past plan. Therefore, in practice, the fuel consumption amount predicting unit 3009 may perform the association process only for past plans from the timing of the last periodic processing to the start of the current processing.

Subsequently, based on the actual result value of the fuel consumption amount associated for each past plan, the fuel consumption amount predicting unit 3009 predicts the fuel consumption amount for each of the future plans that are known from the plan information about the app user that uses the vehicle 10, that is, for each of the future plans that are related to the use of the vehicle 10 and that correspond to the registered plan information and the future plans that are related to the use of the vehicle 10 and that correspond to the unregistered plan information. On this occasion, whether a future plan corresponding to the registered plan information is a plan that is related to the use of the vehicle 10 may be determined, for example, based on whether the registered plan information includes the route information, or actual results of the vehicle 10 having been used in a past plan including the movement to the same place or in the same type of past plan. In this case, the type of the plan is prescribed. At the time of the plan registration, the plan registering unit 3005 may automatically determine the type of the plan based on the content of the plan, and may incorporate the information relevant to the determined plan type, in the plan information. Thereby, the fuel consumption amount predicting unit 3009 can extract the same type of past plan, for each future plan.

As described above, the fuel consumption amount predicting unit 3009 periodically performs the prediction process for the fuel consumption amount of the vehicle 10 for each future plan. Therefore, in practice, the fuel consumption amount predicting unit 3009 may perform the prediction process only for future plans changed or added from the timing of the last periodic processing to the start of the current processing.

For example, for the future plan corresponding to the registered plan information, in the case where there is a past plan including the movement to the same place by the vehicle 10, the fuel consumption amount predicting unit 3009 may employ the fuel consumption amount of the vehicle 10 in the past plan, as a predicted value of the fuel consumption amount in the future plan.

Further, for example, for the future plan corresponding to the registered plan information, the fuel consumption amount predicting unit 3009 may calculate the predicted value of the fuel consumption amount of the vehicle 10, by multiplying the fuel consumption amount of the vehicle 10 in the same type of past plan by a coefficient corresponding to the difference (ratio) in movement distance. On this occasion, in the case where there is a plurality of past plans as the same type of past plan, a past plan on a relatively late date (for example, the most recent past plan) may be preferentially used for the future plan as the object. Thereby, although the fuel consumption amount of the vehicle 10 can change depending on a tendency of driving operation of a driver of the vehicle 10, it is possible to reflect a tendency of driving operation of a relatively recent app user, in the predicted value of the fuel consumption amount in the future plan as the object.

Further, for example, for the future plan that corresponds to the registered plan information and in which the vehicle 10 is used as the precondition for conducting the plan, in the case where the registered plan information includes information about the outward route and information about the homeward route, the fuel consumption amount predicting unit 3009 may predict the fuel consumption amount for the outward route and the fuel consumption amount for the homeward route separately.

Further, for example, for the future plan corresponding to the unregistered plan information, the fuel consumption amount predicting unit 3009 may employ the actual result value of the fuel consumption amount in a past plan having the same content (for example, the actual result value in the most recent past plan having the same content or the actual result value in a plan having the same content on the same day of the week), with no change, as the predicted value of the fuel consumption amount. Further, the fuel consumption amount predicting unit 3009 may employ the average value of actual result values of the fuel consumption amount of the vehicle 10 in past plans having the same content, as the predicted value of the fuel consumption amount. On this occasion, in the averaging process for the actual result values of the fuel consumption amount of the vehicle 10, a greater weight may be given to a past plan on a relatively late date than to a past plan on a relatively early date. Thereby, although the fuel consumption amount of the vehicle 10 can change depending on the tendency of driving operation of the driver of the vehicle 10, it is possible to reflect a tendency of driving operation of a relatively recent app user, in the predicted value of the fuel consumption amount in the future plan as the object.

Further, for example, when the fuel consumption amount predicting unit 3009 predicts the fuel consumption amount for the use of the vehicle 10 in the future plan from the fuel consumption amount associated with the past plan, the fuel consumption amount predicting unit 3009 may consider differences between the route in the route information included in the registered plan information corresponding to the future plan and the actual result (hereinafter, referred to as an “actual movement route”) of a movement route in the past plan as the comparison object. On this occasion, for example, the actual movement route in the past plan as the comparison object may be the route prescribed by the route information that is included in the registered plan information corresponding to the past plan, or may be derived based on a history of the position information about the vehicle 10 that is stored in the vehicle information storage unit 3002. Thereby, it is possible to predict the fuel consumption amount, in consideration of specific differences (distance, gradient, limiting speed and the like) in the movement route of the vehicle 10 between the past plan and the future plan.

Further, for example, when the fuel consumption amount predicting unit 3009 predicts the fuel consumption amount for the use of the vehicle 10 in the future plan from the fuel consumption amount associated with the past plan, the fuel consumption amount predicting unit 3009 may consider the predicted congestion situation on the route in the route information corresponding to the future plan as the prediction object and the actual result of the congestion situation on the actual movement route corresponding to the past plan as the comparison object. The predicted congestion situation and the actual result of the congestion situation are known from the road congestion situation prediction information and the road congestion situation actual result information. Thereby, the fuel consumption amount predicting unit 3009 can reflect the difference in road congestion situation between the route corresponding to the future plan as the prediction object and the actual movement route corresponding to the past plan as the comparison object, in the predicted value of the fuel consumption amount of the vehicle 10. Therefore, it is possible to improve prediction accuracy.

The actual result of the congestion situation on the actual movement route corresponding to the past plan may be determined, for example, using the vehicle speed information about the plurality of vehicles 10 that is held in the vehicle information storage unit 3002.

The fuel replenishment timing predicting unit 3010 predicts a timing (fuel replenishment timing) at which the fuel replenishment of the vehicle 10 is needed, based on the future fuel consumption amount of the vehicle 10 that is predicted by the fuel consumption amount predicting unit 3009 and the remaining fuel amount information about the vehicle 10 that is stored in the vehicle information storage unit 3002. For example, the fuel replenishment timing may be a timing at which the remaining fuel amount of the vehicle 10 becomes equal to or less than a predetermined threshold. Specifically, the fuel replenishment timing predicting unit 3010 may predict a plan that is of the future plans related to the use of the vehicle 10 and in which the vehicle 10 is used in a period including the fuel replenishment timing, based on the predicted value that is predicted by the fuel consumption amount predicting unit 3009 and that is a predicted value of the fuel consumption amount for each future plan related to the use of the vehicle 10, and the current remaining fuel amount of the vehicle 10 based on the remaining fuel amount information. Further, in the case where the route information that corresponds to the future plan and that is related to the use of the vehicle 10 includes the information about the outward route and the information about the homeward route and where the fuel consumption amount predicting unit 3009 predicts the fuel consumption amount for the outward route and the fuel consumption amount for the homeward route separately, the fuel replenishment timing predicting unit 3010 may predict along which route the vehicle 10 travels at the fuel replenishment timing.

In the fuel price prediction information storage unit 3011, prediction information (hereinafter, referred to as “fuel price prediction inform ati on”) relevant to the fuel price is stored. For example, the fuel price prediction information may be periodically acquired from an external institution relevant to the fuel price.

In the GS congestion degree information storage unit 3012, information (hereinafter, referred to as “GS congestion degree information”) relevant to a congestion degree for each of a plurality of fuel replenishment facilities (for example, gasoline stations or hydrogen stations) that is previously registered is stored. The GS congestion degree information may be periodically acquired from an external investigative agency or the like. Further, the GS congestion degree information may be created by periodically analyzing stop-off rates of the vehicles 10 at the registered fuel replenishment facilities based on the position information about the vehicles 10 that is stored in the vehicle information storage unit 3002 and the map information in the map information storage unit 3003.

In response to a plan information acquisition request, the plan information providing unit 3013 (an example of the information providing unit) sends plan information (hereinafter, referred to as “display plan information”) about the app user designated in the request, for displaying the plan information on the user terminal 40 (a display device 46 described later) in a predetermined format designated in the request. On this occasion, the display plan information includes the fuel replenishment timing information about the vehicle 10 that is used by the app user. That is, the plan information providing unit 3013 provides the fuel replenishment timing information about the vehicle 10 that is used by the app user, on a screen (hereinafter, referred to as an “app screen”) of the scheduler app activated in the user terminal 40.

For example, on the app screen of the user terminal 40, the plan information providing unit 3013 may give, to the app user, a notice of a future plan that is of the future plans corresponding to the plan information (that is, the registered plan information and the unregistered plan information) and for which it is predicted that the vehicle 10 is used in a period including the fuel replenishment timing.

Further, for example, on the app screen of the user terminal 40, the plan information providing unit 3013 may give, to the app user, a notice of a date and hour corresponding to the future plan that is of the future plans corresponding to the plan information (that is, the registered plan information and the unregistered plan information) and for which it is predicted that the vehicle 10 is used in a period including the fuel replenishment timing.

Further, for example, on the app screen of the user terminal, the plan information providing unit 3013 may give, to the app user, a notice of information relevant to a fuel replenishment facility as a stop place on a movement route corresponding to a future plan before the fuel replenishment timing of the future plans corresponding to the plan information (that is, the registered plan information and the unregistered plan information). On this occasion, for example, the movement route in the unregistered plan information may be estimated from the history of the position information about the vehicle 10 in the past plan having the same content. Further, the fuel replenishment facility as the stop place that is provided as information may be constituted by one fuel replenishment facility, or may be constituted by a plurality of fuel replenishment facilities. In the case where the fuel replenishment facility that is provided as information is constituted by a plurality of fuel replenishment facilities, information relevant to a plurality of fuel replenishment facilities around a movement route corresponding to one plan may be provided to the app user, or for each of a plurality of plans, information relevant to a fuel replenishment facility around the corresponding movement route may be provided to the app user. Further, for example, there is a possibility that information relevant to the fuel replenishment facility as the stop place on the outward movement route to the destination place corresponding to the plan, that is, on the route in the outward route information included in the registered plan information is provided to the app user. In this case, the plan registering unit 3005 may adjust (correct) the departure hour for the movement (incidental movement plan) by the vehicle 10 before the plan corresponding to the registered plan information, in light of a required time increased due to the stop-off at the fuel replenishment facility. Thereby, even when the app user stops off at the recommended fuel replenishment facility, the app user can reach the destination place for conducting the plan, at a planned hour.

Specifically, the plan information providing unit 3013 may recommend, to the app user, the fuel replenishment facility existing around the movement route corresponding to the future plan for which it is predicted that the vehicle 10 is used in a period including the fuel replenishment timing, as the stop place. On this occasion, in the case of the future plan corresponding to the registered plan information, the movement route is a route in the route information included in the registered plan information. In the case of the future plan corresponding to the unregistered plan information, the movement route may be a route estimated from the history of the position information about the vehicle 10 in the past plan having the same content, as described above.

Further, based on the fuel price prediction information, the plan information providing unit 3013 may recommend, to the app user, the fuel replenishment facility existing around the route in the route information included in the registered plan information corresponding to a plan that is of the future plans corresponding to the plan information (that is, the registered plan information and the unregistered plan information) and that is a plan for a day on which it is predicted that a fuel price is relatively low before the predicted fuel replenishment timing, as the stop place. Thereby, the app user can perform the fuel replenishment of the vehicle 10, on a day on which the fuel price is relatively low.

Further, the plan information providing unit 3013 may recommend the fuel replenishment facility as the above-described stop place, based on information (hereinafter, referred to as “movement history information”) relevant to a movement history of the vehicle 10 that is used by the app user. On this occasion, for example, the movement history information is a history of the position information about the vehicle 10 that is stored in the vehicle information storage unit 3002. More specifically, the plan information providing unit 3013 may extract fuel replenishment facilities having relatively high use frequencies, based on the movement history information and the map information (POI information) in the map information storage unit 3003. Then, the plan information providing unit 3013 may select the fuel replenishment facility as the stop place, from the extracted fuel replenishment facility, and may recommend the selected fuel replenishment facility to the app user. Further, the plan information providing unit 3013 may extract fuel replenishment facilities that were used by the app user in the past, based on the movement history information and the map information (POI information) in the map information storage unit 3003, and may determine whether the app user prefers a self-service-type fuel replenishment facility or a full-service-type fuel replenishment facility, by discriminating whether each of the extracted fuel replenishment facilities is a self-service type or a full-service type. Then, based on the determination result, the plan information providing unit 3013 may recommend an app user's preferred type (a self-service type or a full-service type) of fuel replenishment facility as the stop place. Thereby, the plan information providing unit 3013 can recommend the fuel replenishment facility as the stop place, in view of the preference of the app user.

Further, the plan information providing unit 3013 may select a fuel replenishment facility having a relatively low congestion degree, as the above-described stop place, from a plurality of fuel replenishment facilities, based on the GS congestion degree information for each of the plurality of fuel replenishment facilities, and may recommend the selected fuel replenishment facility to the app user. Thereby, the app user can perform the fuel replenishment in the fuel replenishment facility having a relatively low congestion degree.

Configuration of User Terminal

Similarly to the vehicle information server 20 and the like, functions of the user terminal 40 may be realized by arbitrary hardware or combinations of hardware and software. As shown in FIG. 2B, for example, the user terminal 40 includes a drive device 41, an auxiliary storage device 42, a memory device 43, a CPU 44, an interface device 45, a display device 46 and an input device 47, which are connected with each other by a bus B4.

A hardware configuration of the user terminal 40 is nearly the same as the hardware configurations of the vehicle information server 20 and the like, and therefore, detailed descriptions will be omitted.

As shown in FIG. 3, for example, the user terminal 40 includes a plan registration requesting unit 401, a route search requesting unit 402 and a plan information display processing unit 403, as functional units that are realized when the CPU 44 activates and executes the scheduler app installed in the auxiliary storage device 42.

In response to an app user's operation to the GUI of the app screen, the plan registration requesting unit 401 sends, to the plan information server, the plan registration request including the input plan content and designation information designating a route that is selected from the route search result based on the route search request from the route search requesting unit 402. Thereby, the app user can register the plan information in the plan information server 30, through the operation input on the app screen.

In response to an app user's operation to the GUI of the app screen, the route search requesting unit 402 sends the route search request including the input departure place and destination place, to the plan information server 30. Thereby, in the registration of the plan information, the app user can acquire a specific movement route of the vehicle 10 that corresponds to the plan as the registration object, from the plan information server 30 through the app screen.

In response to an app user's operation to the GUI of the app screen, the plan information display processing unit 403 displays the plan information about the app user on the display device 46 (for example, a liquid crystal display or an organic electroluminescence (EL) display). Specifically, in response to the app user's operation, the plan information display processing unit 403 sends the plan information acquisition request including the display format for the plan information and the like, to the plan information server 30. Then, based on the display plan information returned from the plan information server 30 in response to the plan information acquisition request, the plan information display processing unit 403 displays the plan information on the display device 46, in a display format corresponding to the user's operation (that is, in the display format designated in the plan information acquisition request). Details of the app screen (hereinafter, referred to as “plan information display screen”) of the display device 46 on which the plan information is displayed will be described later (see FIG. 4A to FIG. 4C).

Specific Examples of Method for Providing Plan Information

Next, specific examples of methods by which the plan information server 30 provides the plan information including the fuel replenishment timing to the app user through the user terminal 40 will be described with reference to FIG. 4A to FIG. 4C.

First, FIG. 4A is a diagram showing an example (a plan information display screen 410) of the plan information display screen. In the example, the plan information about the app user is displayed in a format of a plan table for one month (specifically, one month of May 2018). In the example, descriptions will be made below, assuming that the current date is May 13, 2018.

As shown in FIG. 4A, the plan information display screen 410 contains registered plan information 411 registered for May 16, 2018, a predicted fuel consumption amount 412 corresponding to the registered plan information 411, a fuel replenishment timing icon 413 and a fuel replenishment completion icon 414.

Specifically, the registered plan information 411 shows a plan to play in “xx amusement park”.

The predicted fuel consumption amount 412 shows the predicted value of the fuel consumption amount in the plan related to the use of the vehicle 10 on May 16, 2018. Specifically, the predicted fuel consumption amount 412 shows the predicted value of the fuel consumption amount of the vehicle 10 due to the use of the vehicle 10 that corresponds to the plan in the plan information 411, that is, due to the movement to “xx amusement park” and the movement from “xx amusement park”.

In the example, predicted fuel consumption amounts are displayed also on other dates (13 to 15) from the current date in May 2018. Further, actual result values of the fuel consumption amount of the vehicle 10 are displayed on dates (1 to 12) before the current date in May 2018. Further, the display of the predicted fuel consumption amounts including the predicted fuel consumption amount 412 and the display of the actual result values of the fuel consumption amount can be removed depending on a setting operation by the user.

The fuel replenishment timing icon 413 shows that it is predicted that the fuel replenishment timing is during the use of the vehicle 10 in the plan on the date (May 16, 2018) corresponding to the display position. That is, the fuel replenishment timing icon 413 is an example of the fuel replenishment timing information. Specifically, the fuel replenishment timing icon 413 shows that the fuel replenishment timing is during the use of the vehicle 10 corresponding to the plan information 411, that is, during the movement to “xx amusement park” or during the movement from “xx amusement park”. Thereby, the app user can recognize the predicted fuel replenishment timing by checking the fuel replenishment timing icon 413.

The fuel replenishment completion icon 414 shows that the fuel replenishment was performed on the date (May 8, 2018) corresponding to the display position. Thereby, the app user can check the timing at which the fuel replenishment was performed in the past.

In the example, the fuel replenishment timing icon 413 and the fuel replenishment completion icon 414 have the same form (specifically, a fuel replenishment device-like form), and the app user can distinguish between the fuel replenishment timing icon 413 and the fuel replenishment completion icon 414, based on whether the display position is a position after the current date or a position before the current date. However, the form of the fuel replenishment timing icon 413 and the form of the fuel replenishment completion icon 414 may be different from each other.

Next, FIG. 4B is a diagram showing an alternative example (a plan information display screen 420) of the plan information display screen. In the example, the plan information about the app user is displayed in a format of a plan table for a particular day (specifically, May 16, 2018).

As shown in FIG. 4B, the plan information display screen 420 contains a registered plan information 421 and incidental movement plan information 422, 423 showing incidental movement plans corresponding to the registered plan information 421.

The registered plan information 421 shows a plan to play in “xx amusement park” from 10:00 to 12:30.

The incidental movement plan information 422 shows a plan to depart at 8:30 and move by the vehicle 10 from app user's home to “xx amusement park” that is the destination place corresponding to the registered plan information 421 so as to arrive before 10:00.

The incidental movement plan information 423 shows a plan to depart after 12:30 and move by the vehicle 10 from “xx amusement park” to “□□□ port” so as to arrive at 14:00.

Further, the incidental movement plan information 422 includes a fuel replenishment timing icon 424 and a stop place information 425.

The fuel replenishment timing icon 424 shows that it is predicted that the fuel replenishment timing is during the movement by the vehicle 10 corresponding to the incidental movement plan information 423. Thereby, the app user can recognize that it is predicted that the fuel replenishment timing is during the movement to “xx amusement park” by checking the fuel replenishment timing icon 424.

The stop place information 425 shows information relevant to the fuel replenishment facility recommended as the stop place. Thereby, the app user can know the information relevant to a specific fuel replenishment facility as the stop place (stop-off point) for fuel replenishment, without a research by the app user.

Each incidental movement plan information 422, 423 contains a route check button 426.

The route check button 426 is a virtual operation object that allows the app user to check the route information in the incidental movement plan corresponding to the incidental movement plan information 422, 423. The user can check the route information, by performing an operation for designating and deciding the route check button 426 (for example, a touch operation to a position that is on a touch panel mounted on the display device 46 and that corresponds to the route check button 426) such that the display content on the display device 46 transitions to the plan information display screen on which the route information is displayed.

Next, FIG. 4C is a diagram showing a further alternative example (a plan information display screen 430) of the plan information display screen. In the example, the route information (a departure place, a destination place, a route, a stop place and the like) is superimposed and displayed on a map image.

As shown in FIG. 4C, the plan information display screen 430 contains a route 431, a departure place icon 432, a destination place icon 433 and a fuel replenishment facility icon 434 for the stop place in the route information.

The route 431 shows a path on the map image, which is a path from the departure place to the destination place through the stop place in the route information.

The departure place icon 432 shows a departure place in the route information on the map image.

The destination place icon 433 shows a destination place in the route information on the map image.

The fuel replenishment facility icon 434 shows a place on the map image of a fuel replenishment facility that is proposed as the stop place in the route information for the predicted fuel replenishment timing. Thereby, the app user can stop off at the fuel replenishment facility and perform the fuel replenishment of the vehicle 10, at the predicted fuel replenishment timing, without a search for the place of fuel replenishment facility by the app user.

### Operation of Embodiment

Next, the operation of the information providing system 1 (plan information server 30) according to the embodiment will be described.

In the embodiment, the fuel consumption amount predicting unit 3009 predicts the future fuel consumption amount of the vehicle 10, based on the fuel consumption amount actual result information about the vehicle 10 and the plan information about the user of the vehicle 10. Then, the fuel replenishment timing predicting unit 3010 predicts the timing at which the fuel replenishment of the vehicle 10 is needed, based on the future fuel consumption amount of the vehicle 10 that is predicted by the fuel consumption amount predicting unit 3009 and the information relevant to the remaining fuel amount of the vehicle 10.

Thereby, the plan information server 30 can use the past plan and future plan of the user of the vehicle 10. Therefore, the plan information server 30 can know the actual result of the fuel consumption amount of the vehicle 10 when the user used the vehicle 10 in the past plan, and can predict the fuel consumption amount by the future use of the vehicle 10, from the relationship between the past plan and the actual result of the fuel consumption amount, in view of the future plan of the user. Consequently, the plan information server 30 can more accurately predict the timing at which the fuel replenishment of the vehicle 10 is needed, by using the future fuel consumption amount predicted in view of the future plan of the user and the remaining fuel amount of the vehicle 10.

In the embodiment, the fuel consumption amount predicting unit 3009 associates the actual result of the fuel consumption amount of the vehicle 10, for each past plan that is related to the use of the vehicle 10 and that is known from the plan information about the user, based on the fuel consumption amount actual result information about the vehicle 10, and predicts the fuel consumption amount of the vehicle 10 for each future plan that is related to the use of the vehicle 10 and that is known from the plan information about the user, based on the actual result of the fuel consumption amount of the vehicle 10 associated for each past plan. The fuel replenishment timing predicting unit 3010 may predict the timing at which the fuel replenishment of the vehicle 10 is needed, based on the fuel consumption amount of the vehicle 10 for each future plan that is predicted by the fuel consumption amount predicting unit 3009 and the information relevant to the remaining fuel amount of the vehicle 10.

Thereby, using the past plan and future plan of the user of the vehicle 10, the plan information server 30 can specifically predict the future fuel consumption amount of the vehicle 10, and can predict the timing at which the fuel replenishment of the vehicle 10 is needed.

In the embodiment, the plan estimating unit 3007 estimates the plan that is related to the use of the vehicle 10 and that is not registered as the plan information about the user. The fuel consumption amount predicting unit 3009 may associate the actual result of the fuel consumption amount of the vehicle 10, for each past plan that is related to the use of the vehicle 10 and that is registered as the plan information about the user and each past plan that is related to the use of the vehicle 10, that is not registered as the plan information about the user and that is estimated by the plan estimating unit 3007, based on the fuel consumption amount actual result information about the vehicle 10, and may predict the fuel consumption amount of the vehicle 10 for each future plan that is related to the use of the vehicle 10 and that is registered as the plan information about the user and each future plan that is related to the use of the vehicle 10, that is not registered as the plan information about the user and that is estimated by the plan estimating unit 3007, based on the actual result of the fuel consumption amount of the vehicle 10 associated for each past plan.

Thereby, the plan information server 30 can estimate an unregistered plan that the user does not bother to register, as exemplified by work trip, and can use not only registered past and future plans but also unregistered past and future plans. Therefore, the plan information server 30 can more minutely know the relationship between the actual result of the fuel consumption amount of the vehicle 10 and the plan related to the use of the vehicle 10 by the user. Consequently, the plan information server 30 can further accurately predict the timing at which the fuel replenishment of the vehicle 10 is needed.

In the embodiment, the plan information about the user can include the information about the route between the departure place and destination place corresponding to the plan that is related to the use of the vehicle 10 and that is registered. The fuel consumption amount predicting unit 3009 may predict the fuel consumption amount of the vehicle 10 for the future plan that is related to the use of the vehicle 10 and that is registered as the plan information about the user, based on the actual result of the fuel consumption amount of the vehicle 10 associated with the past plan that is related to the use of the vehicle 10 and that is registered as the plan information about the user, the route information corresponding to the past plan, and the route information corresponding to the future plan that is related to the use of the vehicle 10 and that is registered as the plan information about the user.

Thereby, the plan information server 30 can know the route between the departure place and destination place corresponding to each of the past plan and the future plan that are related to the use of the vehicle 10 and that are registered by the user, and can use the route information (for example, distance, gradient and limiting speed). Therefore, for example, the plan information server 30 can know similarities and differences in the route information corresponding to each of the past plan and the future plan, and can specifically predict the fuel consumption amount of the vehicle 10 corresponding to the future plan, from the actual result of the fuel consumption amount of the vehicle 10 corresponding to the past plan.

In the embodiment, the fuel consumption amount predicting unit 3009 may predict the fuel consumption amount of the vehicle 10 in the future plan that is related to the use of the vehicle 10 and that is registered as the plan information about the user, based on the congestion situation actual result information about route on the date and hour in the past plan that is related to the use of the vehicle 10 and that is registered as the plan information about the user and the congestion situation prediction information about the route on the date and hour in the future plan that is related to the use of the vehicle 10 and that is registered as the plan information about the user.

Thereby, the plan information server 30 can use the congestion situation actual result information about the route corresponding to the past plan on the date and hour in the past plan, and the congestion situation prediction information about the route corresponding to the future plan on the date and hour in the future plan. Therefore, the plan information server 30 can predict the fuel consumption amount of the vehicle 10 corresponding to the future plan, from the actual result of the fuel consumption amount of the vehicle 10 corresponding to the past plan, in consideration of the congestion situations on the route at the times of uses of the vehicle 10 corresponding to the past plan and the future plan. Consequently, the plan information server 30 can more accurately predict the fuel consumption amount of the vehicle 10 corresponding to the future plan.

In the embodiment, the plan information providing unit 3013 may provide, to the user, the information (fuel replenishment timing information) relevant to the timing at which the fuel replenishment of the vehicle 10 is needed and that is predicted by the fuel replenishment timing predicting unit 3010, through the user terminal 40.

Thereby, the plan information server 30 can prompt the user to perform the fuel replenishment at a more appropriate timing.

In the embodiment, the plan information providing unit 3013 may provide, to the user, the information relevant to the fuel replenishment facility as the stop place on the movement route corresponding to a plan before the timing at which the fuel replenishment of the vehicle 10 is needed and that is predicted by the fuel replenishment timing predicting unit 3010, and the plan is a future plan that is related to the use of the vehicle 10 and that is registered as the plan information about the user.

Thereby, the plan information server 30 can specifically provide the information relevant to the fuel replenishment facility that is around the movement route corresponding to the future plan and at which the user can stop off, as the information relevant to the timing at which the fuel replenishment of the vehicle 10 is needed.

In the embodiment, the plan information providing unit 3013 may provide, to the user, the information relevant to the fuel replenishment facility as the stop place on the movement place corresponding to a plan for a day on which it is predicted that the fuel price is relatively low before the timing at which the fuel replenishment of the vehicle 10 is needed and that is predicted by the fuel replenishment timing predicting unit 3010, based on the fuel price prediction information, and the plan is a future plan that is related to the use of the vehicle 10 and that is registered as the plan information about the user.

Thereby, the plan information server 30 can perform the information provision to the user, such that the user can stop off at the fuel replenishment facility at a timing at which the fuel price is relatively low before the predicted timing at which the fuel replenishment of the vehicle 10 is needed.

In the embodiment, the plan information providing unit 3013 may provide, to the user, the information relevant to the fuel replenishment facility as the stop place, based on the movement history information about the vehicle 10.

Thereby, by using the movement history of the vehicle 10, the plan information server 30 can know the preference (for example, a fuel replenishment facility that is frequently used, and information of whether the fuel replenishment facility at which the user stops off is a self-service type or a full-service type) of the user relevant to the fuel replenishment facility. Consequently, the plan information server 30 can provide, to the user, the information relevant to the fuel replenishment facility as the stop place, in view of the preference of the user relevant to the fuel replenishment facility.

In the embodiment, the plan information providing unit 3013 may select the fuel replenishment facility as the stop place from a plurality of fuel replenishment facilities, based on the GS congestion degree information, and may provide, to the user, the information relevant to the selected fuel replenishment facility.

Thereby, by using the information relevant to the congestion degree for each of the plurality of fuel replenishment facilities, for example, the plan information server 30 can provide, to the user, the information relevant to a fuel replenishment facility that is not relatively congested, as the stop place of the plurality of fuel replenishment facilities.

The embodiment of the disclosure has been described above in detail. The disclosure is not limited to the particular embodiment, and various modifications and improvements can be made within the scope of the spirit of the disclosure described in the claims.

For example, in the above-described embodiment, the function of the vehicle information server 20 and the function of the plan information server 30 may be integrated in a single server device.

In the above-described embodiment, the fuel replenishment timing information is provided to the user, with use of the scheduler app. However, the fuel replenishment timing information may be given to the user, without the scheduler app. In this case, the function of the plan estimating unit 3007, the function of the fuel consumption amount predicting unit 3009, the function of the fuel replenishment timing predicting unit 3010, functions relevant to the provision of the fuel replenishment timing information to the vehicle user in the plan information providing unit 3013, and related information resources may be transferred to the vehicle information server 20 (an example of the information processing device). Specifically, the plan information is disclosed from the plan information server 30 to the vehicle information server 20. Thereby, similarly to the plan information server 30 in the above-described embodiment, the vehicle information server 20 can predict the fuel consumption amount of the vehicle 10, can predict the fuel replenishment timing of the vehicle 10, and can provide the fuel replenishment timing information to the vehicle user.

In the above-described embodiment, the function of the fuel consumption amount predicting unit 3009, the function of the fuel replenishment timing predicting unit 3010, functions relevant to the provision of the fuel replenishment timing information to the vehicle user in the plan information providing unit 3013, and related information resources may be transferred to each vehicle 10 (for example, the ECU 11 (an example of the information processing device)). In this case, the plan information about the app user that uses the vehicle 10 is disclosed to the ECU 11 of the vehicle 10, directly from the plan information server 30 or through the vehicle information server 20. Thereby, while using the vehicle information (fuel consumption related information) about the vehicle 10, the ECU 11 of the vehicle 10 can predict the fuel consumption amount of the vehicle 10, can predict the fuel replenishment timing of the vehicle 10, and can provide the fuel replenishment timing information to the user of the vehicle 10.

What is claimed is:

1. An information processing device comprising circuitry configured to
predict a future fuel consumption amount of a vehicle, based on information relevant to an actual result of a fuel consumption amount of the vehicle and information relevant to a plan of a user of the vehicle; and
predict a fuel replenishment timing at which a fuel replenishment of the vehicle is needed, based on the future fuel consumption amount of the vehicle and information relevant to a remaining fuel amount of the vehicle.

2. The information processing device according to claim 1, wherein
the circuitry is configured to
associate the actual result of the fuel consumption amount of the vehicle, for each past plan that is related to use of the vehicle and that is known from the information relevant to the plan of the user, based on the information relevant to the actual result of the fuel consumption amount of the vehicle,
predict the fuel consumption amount of the vehicle for each future plan that is related to the use of the vehicle and that is known from the information relevant to the plan of the user, based on the actual result of the fuel consumption amount of the vehicle associated for each past plan, and
predict the timing at which the fuel replenishment of the vehicle is needed, based on the fuel consumption amount of the vehicle for each future plan and the information relevant to the remaining fuel amount of the vehicle.

3. The information processing device according to claim 2, wherein
the circuitry is configured to
estimate a plan that is related to the use of the vehicle and that is unregistered as the information relevant to the plan of the user,
associate the actual result of the fuel consumption amount of the vehicle for each past plan that is related to the use of the vehicle and that is registered as the information relevant to the plan of the user, and for each past plan that is related to the use of the vehicle and that is unregistered as the information relevant to the plan of the user, based on the information relevant to the actual result of the fuel consumption amount of the vehicle, and
predict the fuel consumption amount of the vehicle for each future plan that is related to the use of the vehicle and that is registered as the information relevant to the plan of the user, and for each future plan that is related to the use of the vehicle and that is unregistered as the information relevant to the plan of the user, based on the actual result of the fuel consumption amount of the vehicle associated for each past plan.

4. The information processing device according to claim 2, wherein:
a part of the information relevant to the plan of the user is information relevant to a route between a departure place and a destination place corresponding to a plan that is related to the use of the vehicle and that is registered; and
the circuitry is configured to predict the fuel consumption amount of the vehicle for a future plan that is related to the use of the vehicle and that is registered as the information relevant to the plan of the user, based on the actual result of the fuel consumption amount of the vehicle associated with a past plan that is related to the use of the vehicle and that is registered as the information relevant to the plan of the user, based on information relevant to the route corresponding to the past plan, and based on information relevant to the route corresponding to the future plan that is related to the use of the vehicle and that is registered as the information relevant to the plan of the user.

5. The information processing device according to claim 4, wherein
the circuitry is configured to predict the fuel consumption amount of the vehicle for the future plan that is related to the use of the vehicle and that is registered as the information relevant to the plan of the user, based on actual result information relevant to a congestion situation on the route on a date and hour in the past plan that is related to the use of the vehicle and that is registered as the information relevant to the plan of the user, and based on prediction information relevant to a congestion situation on the route on a date and hour in the future plan that is related to the use of the vehicle and that is registered as the information relevant to the plan of the user.

6. The information processing device according to claim 1, wherein
the circuitry is configured to provide, to the user, information relevant to the timing at which the fuel replenishment of the vehicle is needed, through a user terminal.

7. The information processing device according to claim 6, wherein
the circuitry is configured to provide, to the user, information relevant to a fuel replenishment facility as waypoint on a movement route corresponding to a particular plan before the timing at which the fuel replenishment of the vehicle is needed, the particular plan being a future plan that is related to the use of the vehicle and that is registered as the information relevant to the plan of the user.

8. The information processing device according to claim 7, wherein
the circuitry is configured to provide, to the user, the information relevant to the fuel replenishment facility as the waypoint on the movement place corresponding to a plan for a day on which it is predicted that a fuel price is relatively low before the timing at which the fuel replenishment of the vehicle is needed, based on prediction information relevant to the fuel price, the plan being a future plan that is related to the use of the vehicle and that is registered as the information relevant to the plan of the user.

9. The information processing device according to claim 7, wherein
the circuitry is configured to provide, to the user, the information relevant to the fuel replenishment facility as the waypoint, based on information relevant to a movement history of the vehicle.

10. The information processing device according to claim 7, wherein
the circuitry is configured to
select the fuel replenishment facility as the waypoint from fuel replenishment facilities, based on information relevant to a congestion degree for each of the fuel replenishment facilities, and
provide, to the user, information relevant to the fuel replenishment facility that is selected.

11. The information processing device according to claim 3, wherein:
a part of the information relevant to the plan of the user is information relevant to a route between a departure place and a destination place corresponding to a plan that is related to the use of the vehicle and that is registered; and
the circuitry is configured to predict the fuel consumption amount of the vehicle for a future plan that is related to the use of the vehicle and that is registered as the information relevant to the plan of the user, based on the actual result of the fuel consumption amount of the vehicle associated with a past plan that is related to the use of the vehicle and that is registered as the information relevant to the plan of the user, based on information relevant to the route corresponding to the past plan, and based on information relevant to the route corresponding to the future plan that is related to the use of the vehicle and that is registered as the information relevant to the plan of the user.

12. The information processing device according to claim 2, wherein
the circuitry is configured to provide, to the user, information relevant to the timing at which the fuel replenishment of the vehicle is needed, through a user terminal.

13. The information processing device according to claim 3, wherein
the circuitry is configured to provide, to the user, information relevant to the timing at which the fuel replenishment of the vehicle is needed, through a user terminal.

14. The information processing device according to claim 4, wherein
the circuitry is configured to provide, to the user, information relevant to the timing at which the fuel replenishment of the vehicle is needed, through a user terminal.

15. The information processing device according to claim 5, wherein
the circuitry is configured to provide, to the user, information relevant to the timing at which the fuel replenishment of the vehicle is needed, through a user terminal.

16. The information processing device according to claim 8, wherein
the circuitry is configured to provide, to the user, the information relevant to the fuel replenishment facility as the waypoint, based on information relevant to a movement history of the vehicle.

17. The information processing device according to claim 8, wherein
the circuitry is configured to
select the fuel replenishment facility as the waypoint from fuel replenishment facilities, based on information relevant to a congestion degree for each of the fuel replenishment facilities, and
provide, to the user, information relevant to the fuel replenishment facility that is selected.

18. The information processing device according to claim 9, wherein
the circuitry is configured to
select the fuel replenishment facility as the waypoint from fuel replenishment facilities, based on information relevant to a congestion degree for each of the fuel replenishment facilities, and
provide, to the user, information relevant to the fuel replenishment facility that is selected.

19. An information processing method that is executed by an information processing device, the information processing method comprising:
a fuel consumption amount predicting step of predicting a future fuel consumption amount of a vehicle, based on information relevant to an actual result of a fuel consumption amount of the vehicle and information relevant to a plan of a user of the vehicle; and
a fuel replenishment timing predicting step of predicting a timing at which a fuel replenishment of the vehicle is needed, based on the future fuel consumption amount of the vehicle and information relevant to a remaining fuel amount of the vehicle.

20. A non-transitory storage medium in which a program is stored, the program being executed by an information processing device and causing the information processing device to execute:
a fuel consumption amount predicting step of predicting a future fuel consumption amount of a vehicle, based on information relevant to an actual result of a fuel consumption amount of the vehicle and information relevant to a plan of a user of the vehicle; and
a fuel replenishment timing predicting step of predicting a timing at which a fuel replenishment of the vehicle is needed, based on the future fuel consumption amount of the vehicle and information relevant to a remaining fuel amount of the vehicle.
